(19) United States
(12) Patent Application Publication
(10) Pub. No.: US 2008/0122263 A1
(43) Pub. Date: May 29, 2008

(54) DOOR MODULE FOR A VEHICLE

(76) Inventors: Markus Waroch, Isenbuettel (DE); Juergen Berbner, Sassenburg (DE)

Correspondence Address: CARLSON, GASKEY & OLDS, P.C., 400 WEST MAPLE ROAD, SUITE 350, BIRMINGHAM, MI, 48009, US

(21) Appl. No.: 11/770,812

(22) Filed: Jun. 29, 2007

(30) Foreign Application Priority Data
Jul. 3, 2006 (DE) 10 2006 030 650.3

(51) Int. Cl. B60J 1/17

(52) U.S. Cl. 296/201; 49/375

(57) ABSTRACT

An aggregate support is attachable in a side structure of a vehicle, such as for instance in a vehicle door, for example. The aggregate support includes a mount for a window pane that guides the window pane when the latter is in a lowered position.

### RELATED APPLICATIONS

The application claims priority to German Application No. 10 2006 030650.3, which was filed on Jul. 3, 2006.

### BACKGROUND OF THE INVENTION

The invention relates to an aggregate support that is attachable in a side structure of a vehicle, such as in a vehicle door for example.

The aggregate support serves to integrate several components that may be arranged in a vehicle door, or also in a side structure of the vehicle body at a level of rear seat benches in a two-door vehicle configuration. These components are, for instance, window lifter rails, a drive motor for a window lifter mechanism, the window lifter mechanism itself, a door control module etc. The employment of an aggregate support makes it possible to pre-assemble these components, so that there is only one single part, namely the aggregate support, which has to be connected with the side structure of the vehicle during the final assembly of the vehicle.

In one known configuration, aggregate supports are firmly connected with a window lifter rail, or are even made in one piece therewith. The advantage of this configuration is that a window pane is reliably guided under each and every situation. However, the disadvantage is that a comparably high friction occurs.

It is the object of the invention to further develop aggregate supports such that the demands with respect to the guidance of the window pane are met, in addition to minimizing the friction.

### SUMMARY OF THE INVENTION

In order to solve this problem, the invention provides a mount for a window pane, which is able to guide the window pane when the latter is in a lowered position. The invention is based on the knowledge that a guide for the window pane in a door well is only required if the pane is in an entirely lowered position or close to this position. It will be sufficient if the mount guides the window pane only in this region. The mount prevents the window pane from performing undesired movements when a vehicle door is slammed with the window pane being in its lower position for example. At the same time, undesired and unneeded friction will be prevented as the window pane does not engage the mount along a major part of its displacement path.

According to one embodiment of the invention, the mount is implemented as a rail that is able to laterally encompass the window pane. From the window guide rail already known from prior art, which guides the window pane along its entire displacement path, only a small residual piece will be left over in this embodiment, which manages the guidance exclusively in crucial regions of the movement path of the window pane.

According to a further embodiment, the mount is implemented as a slot in which a lower edge of the window pane can be inserted. This slot may be implemented in a block-like abutment on the aggregate support. This will result in a very simple construction.

In one example, the mount is made in one piece with the aggregate support. A very low expenditure in manufacturing will arise especially in case the aggregate support is made of plastic.

These and other features of the present invention can be best understood from the following specification and drawings, the following of which is a brief description.

### BRIEF DESCRIPTION OF THE DRAWINGS

FIG. 1 is a side view of an aggregate support according to a first embodiment.

FIG. 2 is a perspective view of an aggregate support according to a second embodiment.

FIG. 3 is a side view of the aggregate support of FIG. 2.

FIG. 4 shows a section along plane IV-IV of FIG. 3.

### DETAILED DESCRIPTION OF THE PREFERRED EMBODIMENT

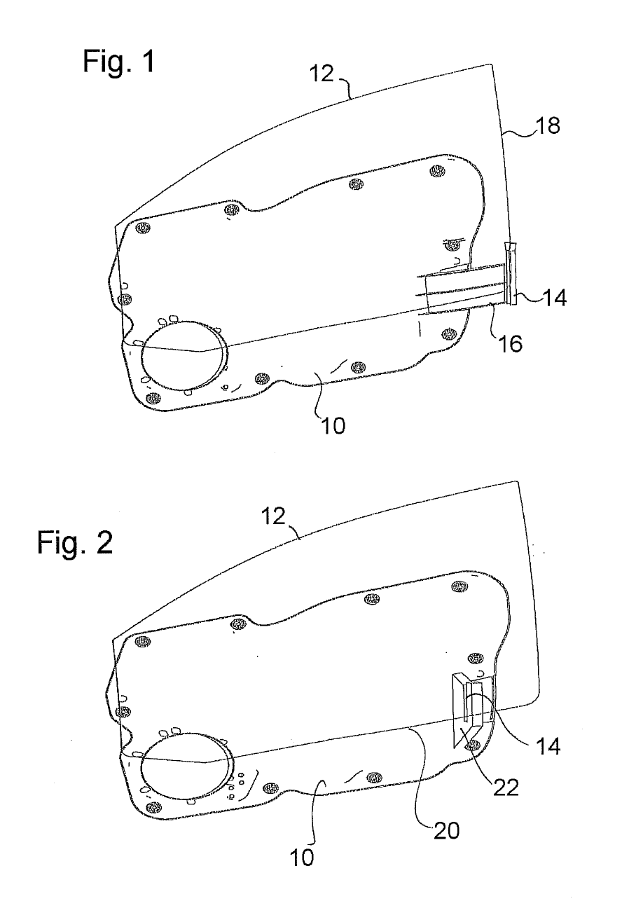

FIG. 1 shows an aggregate support 10 that is implemented in the form of a plate of plastic. Various components can be attached to the aggregate support 10, such as a window lifter system, a door lock, a door control module, etc. The aggregate support 10 itself will be attached in a side structure of a vehicle body, for instance in a vehicle door or in the side structure between a B-column and a C-column.

Also shown in FIG. 1 is a window pane 12, which later on will likewise be attached in the side structure of the vehicle, and can be shifted by a window lifter between a closed and an opened position. FIG. 1 shows the window pane 12 in the opened position where the window pane 12 is moved to its lowermost position.

Provided on the aggregate support 10 is a mount 14 that serves as a guide and is connected in one piece with the aggregate support 10 by a protruding arm 16. The mount 14 is implemented as a rail that encompasses a side edge 18 of the window pane 12. It can be seen that the mount 14 has a comparably small length in a vertical direction. As such, the mount 14 can guide the window pane 12 only when the latter is in its lowered position, or at least near its entirely lowered position. Lead-in ramps are provided at an upper edge of the mount 14, which make the window pane 12 reliably glide into the mount 14 when the window pane 12 is being lowered.

As soon as the window pane 12, starting from its entirely lowered position, has been shifted upwards by a length of about one hand, the window pane 12 leaves the mount 14, so that no friction losses whatsoever will be generated. In the entirely lowered position or near this position, the mount 14 makes sure that the window pane 12 cannot perform excessively intense movements relative to the aggregate support 10, for instance when the vehicle door is slammed.

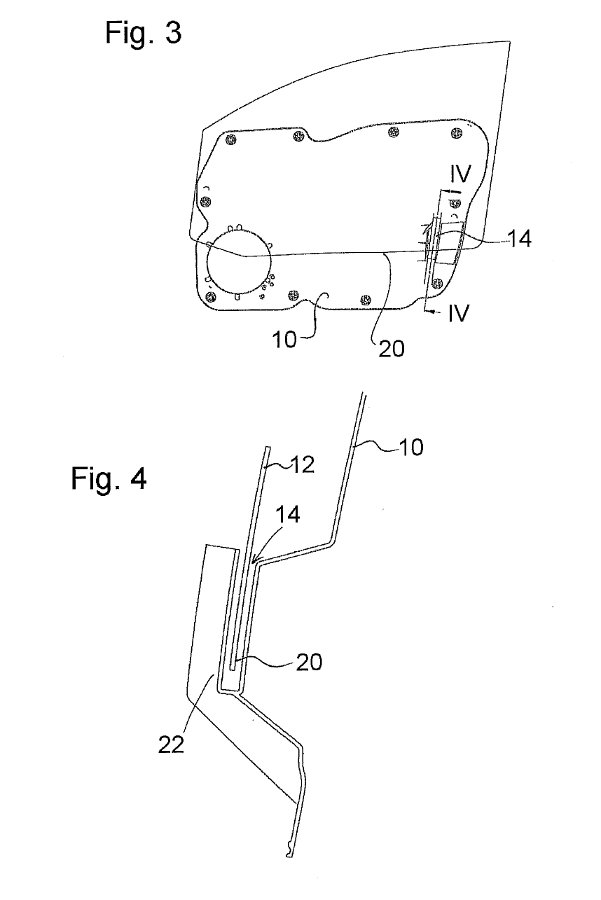

FIGS. 2 to 4 show a second embodiment. The same reference symbols will be used for the components which are known from the first embodiment, and in this respect reference is made to the above explanations.

The difference between the first and second embodiments is that the mount 14 in the second embodiment does not engage the side edge 18 of the window pane 12, but instead engages a lower edge 20. To this end, the mount 14 is implemented as a slot in a block-like abutment 22. The window pane 12 will enter this slot when the window pane 12 is being lowered.

In both embodiments the mount 14 can be made in one piece with the aggregate support 10.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. An aggregate support attachable in a side structure of a vehicle comprising:
a mount for a window pane that guides the window pane when the window pane is in a lowered position.

2. The aggregate support according to claim 1, wherein the mount comprises a rail that laterally encompasses the window pane.

3. The aggregate support according to claim 2, wherein the mount is arranged on a protruding arm.

4. The aggregate support according to claim 1, wherein the mount comprises a slot in which a lower edge of the window pane can be inserted.

5. The aggregate support according to claim 4, wherein the slot is implemented in a block-like abutment.

6. The aggregate support according to claim 1, wherein the mount is made in one piece with the aggregate support.

7. The aggregate support according to claim 1, wherein the mount is made of plastic.
